(19) United States
(12) Patent Application Publication
(10) Pub. No.: US 2026/0249482 A1
(43) Pub. Date: Aug. 27, 2026

(54) TERMINAL SUPPORT DEVICE, TEACHING OPERATION DEVICE, AND ROBOT CONTROL SYSTEM

(71) Applicant: FANUC CORPORATION, Yamanashi (JP)

(72) Inventor: Hidetada Hara, Yamanashi (JP)

(21) Appl. No.: 18/992,061

(22) PCT Filed: Sep. 16, 2022
(86) PCT No.: PCT/JP2022/034815

§ 371 Date: Jan. 7, 2025

(51) Int. Cl. B25J 13/06; G05B 19/425

(52) U.S. Cl. CPC B25J 13/06; G05B 19/425

(57) ABSTRACT

This terminal support device comprises an attachment pedestal for detachably attaching a portable communication terminal that commands operation of a robot via wireless communication to a control device of the robot in accordance with teaching operation content, a safety switch that outputs a safety signal for the control device, an interface unit to which is connected an electrical cable comprising a signal line for transmission of the safety signal to the control device and a power source line for transmission of electric power that is supplied from the control device, and a wireless power transmission unit that performs wireless power transmission, to the portable communication terminal, of a portion of the electric power that is received from the control device via the interface unit and the power source line of the electrical cable.

### CROSS-REFERENCE TO RELATED APPLICATIONS

This application is a National Stage application of International Application No. PCT/JP2022/034815 filed Sep. 16, 2022.

### BACKGROUND

### Field

The present disclosure relates to a terminal support device, a teaching operation device, and a robot control system.

### Discussion of the Related Art

A teaching operation device referred to as a teaching pendant connected to a controller of an industrial robot is used for teaching of the robot. A worker can perform registration and editing of an operation program related to a robot, condition setting, state display, teaching of the robot, a manual operation, and the like by using a teaching operation device. A teaching operation device is provided with safety switches, such as an enable switch and an emergency stop button, in order to avoid an unexpected motion of a robot and secure safety of a machine and a worker in a surrounding area.

In recent years, a teaching operation device performing a teaching operation on a robot with a general-purpose mobile communication terminal, such as a tablet, has been used instead of hardware dedicated to a teaching operation device in terms of cost reduction, securing of versatility, and the like. In the teaching operation device, a mobile communication terminal is attachably and detachably attached to a terminal support device as a base member provided with safety switches.

For example, Paragraph [0025] in JP2002-154085A describes “On the other hand, the operation device 18 can be used in a state of being equipped on the controller 12 or a state of being separated as illustrated in FIG. 1. Then, in the separated state of the operation device 18, a maintenance manager of the system 10 performs an operation on the system 10, teaching of the articulated robot 16, and the like by supporting the operation device 18 with one hand and operating a switch 18a placed on the surface, a touch switch displayed on a display unit 22, and the like with the other hand.”

For example, Paragraph [0018] in JP2015-006115A describes “For example, the charging device 2 may be a charging stand on which the portable operation device 1 is placed during charging, such as a cradle illustrated in FIG. 2 and FIG. 3, or may be a device connected to the portable operation device 1 by a cable or the like during charging.”

### SUMMARY

A teaching operation device configured with a general-purpose mobile communication terminal and a terminal support device generally guarantees safety of a robot control system by connecting the terminal support device provided with safety switches to a controller of a robot through a wired communication. Since the mobile communication terminal has a wireless communication function, it is relatively easy to enable wireless communication for a teaching operation using the mobile communication terminal between the mobile communication terminal and the controller of the robot. On the other hand, it is important in providing a teaching operation using the mobile communication terminal to stably secure driving power for the mobile communication terminal. It is desired that the teaching operation device configured with the mobile communication terminal and the terminal support device easily secures driving power for the mobile communication terminal.

According to an aspect of the present disclosure, a terminal support device includes: an attachment base attachably and detachably attaching a mobile communication terminal configured to command a controller of a robot regarding a motion of the robot through a wireless communication, based on a teaching operation content; a safety switch configured to output a safety signal to the controller; an interface unit configured to be connected to an electric cable including a signal line transmitting the safety signal to the controller and a power line transmitting electric power supplied from the controller; and a wireless power transmission unit configured to wirelessly feed part of electric power received from the controller through the power line in the electric cable and the interface unit to the mobile communication terminal.

### BRIEF DESCRIPTION OF DRAWINGS

FIG. 1 is a diagram illustrating a robot control system according to a first embodiment of the present disclosure.

FIG. 2 is a block diagram illustrating a terminal support device in a robot control system according to each of first and second embodiments of the present disclosure.

FIG. 3 is a block diagram illustrating a mobile communication terminal in the robot control system according to the first embodiment of the present disclosure.

FIG. 4 is a diagram illustrating wireless power feeding and power distribution in the robot control system according to the first embodiment of the present disclosure.

FIG. 5 is a diagram illustrating the robot control system according to the second embodiment of the present disclosure.

FIG. 6 is a block diagram illustrating a mobile communication terminal in the robot control system according to the second embodiment of the present disclosure.

FIG. 7 is a diagram illustrating wireless power feeding and power distribution in the robot control system according to the second embodiment of the present disclosure.

### DESCRIPTION OF EMBODIMENTS

A terminal support device, a teaching operation device, and a robot control system according to each embodiment will be described below with reference to drawings. In the following description, components with the same or similar functions are given the same sign. Then, redundant description of the components may be omitted. In the following description, “wireless power feeding” means power feeding performed without a cable involved (i.e., wirelessly).

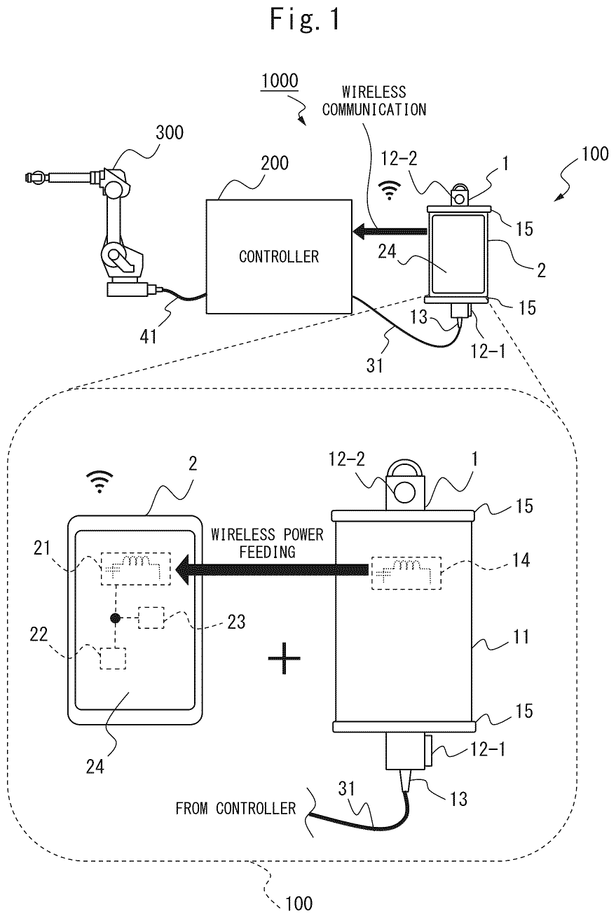

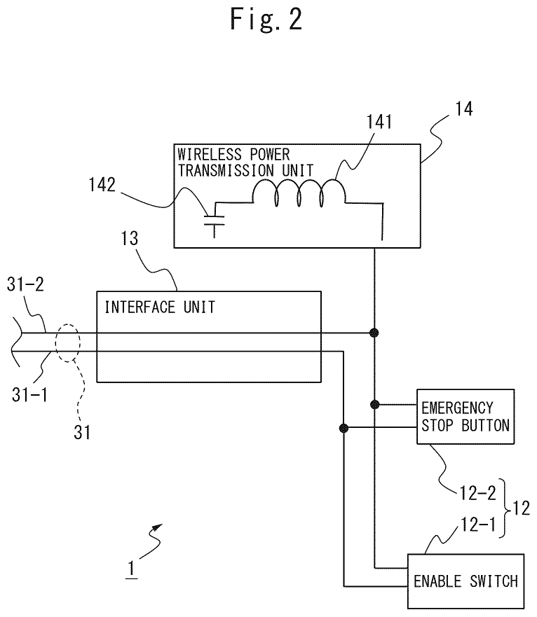

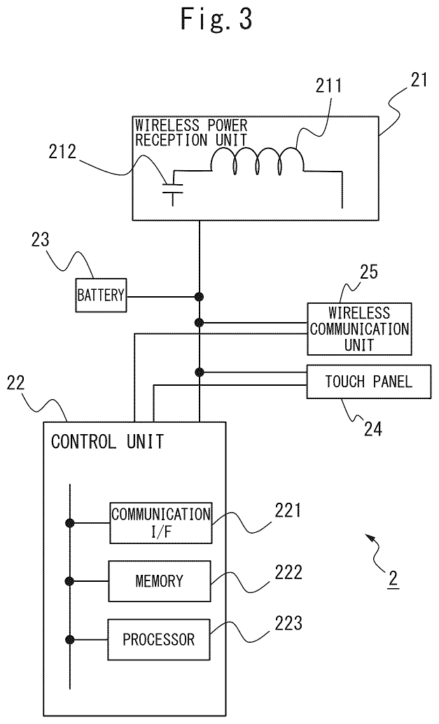

FIG. 1 is a diagram illustrating a robot control system according to a first embodiment of the present disclosure. FIG. 2 is a block diagram illustrating a terminal support device in a robot control system according to each of first and second embodiments of the present disclosure. The block diagram illustrated in FIG. 2 is applied not only to the first embodiment but also to the second embodiment. FIG. 3 is a block diagram illustrating a mobile communication terminal in the robot control system according to the first embodiment of the present disclosure.

The robot control system 1000 according to the first embodiment of the present disclosure includes a teaching operation device 100 and a controller 200.

A robot 300 is connected to the controller 200 in a wired-connection-enabled and power-transmission-enabled manner through a cable 41 (hereinafter referred to as “a robot cable 41”). The motion of the robot 300 is controlled by the controller 200. An arithmetic processing device (at least one processor) and a storage device (at least one memory) are provided in the controller 200. Examples of the arithmetic processing device include an IC, an LSI, a CPU, an MPU, and a DSP. Examples of the memory include electrically erasable/recordable nonvolatile memories, such as an EEPROM (registered trademark), and random-access memories capable of high-speed read/write, such as a DRAM and an SRAM. For example, the controller 200 including the arithmetic processing device is a function module provided by control software (a computer program) executed on a processor. By operating the arithmetic processing device in accordance with the control software, each type of processing in the controller 200 controlling the motion of the robot 300 can be provided. The control software program for executing processing in the controller 200 may be provided in a form of being recorded on a computer-readable recording medium such as a semiconductor memory, a magnetic recording medium, or an optical recording medium. Alternatively, the controller 200 may be provided as a semiconductor integrated circuit in which a computer program providing the function is written.

The controller 200 is connected to an external commercial power source (unillustrated). The controller 200 distributes electric power supplied from the commercial power source into driving power for the controller 200 itself and electric power supplied to a terminal support device 1. Part of the electric power supplied to the controller 200 from the commercial power source is supplied to the terminal support device 1 through a power line 31-2 in an electric cable 31 to be described later. The controller 200 may supply part of the electric power supplied from the commercial power source to the robot 300 as driving power.

The teaching operation device 100 is configured with a mobile communication terminal 2 and the terminal support device 1.

The terminal support device 1 includes an attachment base 11, a safety switch 12, an interface unit 13, and a wireless power transmission unit 14.

The terminal support device 1 is connected to the controller 200 in a wired-connection-enabled and power-transmission-enabled manner through the electric cable 31. The electric cable 31 includes a signal line 31-1 transmitting a safety signal from the safety switch 12 to the controller 200 and the power line 31-2 transmitting electric power from the controller 200 to the terminal support device 1. The electric cable 31 is connected to the interface unit 13.

The attachment base 11 is a base for attachably and detachably attaching the mobile communication terminal 2 to the terminal support device 1. The attachment base 11 includes a holding mechanism 15 for holding the mobile communication terminal 2. As an example, the holding mechanism 15 in FIG. 1 is configured with a spring mechanism holding the mobile communication terminal 2 on the attachment base 11 in such a way as to sandwich the mobile communication terminal 2. Other examples of the holding mechanism 15 include an air spring mechanism holding the mobile communication terminal 2 on the attachment base 11 by using air pressure, a magnet or an electromagnet holding the mobile communication terminal 2 on the attachment base 11 by magnetic force, screws securing the mobile communication terminal 2 to the attachment base 11, and an affixing member affixing the mobile communication terminal 2 to the attachment base 11.

The safety switch 12 outputs a safety signal to the controller 200. The safety signal output from the safety switch is sent to the controller 200 through the signal line in the electric cable 31. The safety switch 12 includes an enable switch 12-1 and an emergency stop button 12-2.

The enable switch 12-1 outputs, as a safety signal, an enable signal permitting control of the motion of the robot 300 by the controller 200 through the mobile communication terminal 2 while continuing to be depressed (turned on) and prohibiting control of the motion of the robot 300 by the controller 200 through the mobile communication terminal 2 by release of the depressed (turned-on) state. An enable signal based on an operation content on the enable switch 12-1 is transmitted to the controller 200 through the interface unit 13 in the terminal support device 1 and the signal line 31-1 in the electric cable 31. For example, the robot 300 does not move by any operation through the mobile communication terminal 2 while the enable switch 12-1 is not being depressed. An operation on the robot 300 through the mobile communication terminal 2 is enabled while the enable switch 12-1 is being depressed.

The emergency stop button 12-2 outputs, as a safety signal, an emergency stop signal commanding the controller 200 to cause the robot 300 to make an emergency stop. When the emergency stop button 12-2 is depressed (turned on), an emergency stop signal is transmitted to the controller 200 through the interface unit 13 in the terminal support device 1 and the signal line 31-1 in the electric cable 31. When receiving an emergency stop signal, the controller 200 performs control of causing the robot 300 to make an emergency stop.

There is no direct electrically wired connection and wired communication through a cable between the terminal support device 1 and the mobile communication terminal 2 regardless of whether the mobile communication terminal 2 is attached to the terminal support device 1. However, wireless power feeding from the terminal support device 1 to the mobile communication terminal 2 is performed. Wireless power feeding refers to power feeding performed in a contactless manner without a cable involved (i.e., wirelessly). The terminal support device 1 includes the wireless power transmission unit 14 for wireless power feeding to the mobile communication terminal 2.

The terminal support device 1 wirelessly feeds part of electric power supplied from the controller 200 to the mobile communication terminal 2 through the wireless power transmission unit 14. As will be described later, the mobile communication terminal 2 is provided with a wireless power reception unit 21 configured to receive electric power wirelessly fed from the terminal support device 1.

Examples of a method used for wireless power feeding between the terminal support device 1 and the mobile communication terminal 2 include magnetic field coupling (electromagnetic induction), electric field coupling, magnetic field resonant coupling (magnetic field resonance), and electric field resonant coupling (electric field resonance).

For example, when magnetic field resonant coupling is used for wireless power feeding between the terminal support device 1 and the mobile communication terminal 2, the wireless power transmission unit 14 is configured with a resonance circuit including a power-transmitting coil 141 and a power-transmitting resonant capacitor 142. The power-transmitting coil 141 produces magnetic field resonance with a power-receiving coil 211 to be described later by electric power flowing into the wireless power transmission unit 14 at a predetermined resonance frequency. Consequently, electric power is wirelessly transmitted from the power-transmitting coil 141 to the power-receiving coil 211.

Since magnetic resonant coupling is adopted as an example, the wireless power transmission unit 14 is assumed to include the power-transmitting coil 141 and the power-transmitting resonant capacitor 142. When wireless power feeding is performed between the terminal support device 1 and the mobile communication terminal 2 by magnetic field coupling, electric field coupling, or electric field resonant coupling, the wireless power transmission unit 14 is configured based on each type of coupling.

The mobile communication terminal 2 is attachably and detachably attached to the attachment base 11 in the terminal support device 1. The mobile communication terminal 2 is a general-purpose portable information communication terminal that can wirelessly communicate with an external device. Examples of the mobile communication terminal 2 include a tablet terminal (tablet PC) and a smartphone.

The mobile communication terminal 2 includes the wireless power reception unit 21, a control unit 22, a battery 23, a touch panel 24, and a wireless communication unit 25.

The wireless power reception unit 21 is configured to receive electric power wirelessly fed from the wireless power transmission unit 14 in the terminal support device 1.

For example, when magnetic field resonant coupling is used for wireless power feeding between the terminal support device 1 and the mobile communication terminal 2, the wireless power reception unit 21 is configured with a resonance circuit including the power-receiving coil 211 and a power-receiving resonant capacitor 212. Various parameters of the power-receiving coil 211 and the power-receiving resonant capacitor 212 (such as the outer diameter and the inner diameter of the power-receiving coil 211, the number of turns of the power-receiving coil 211, and the capacitance of the power-receiving resonant capacitor 212) are determined in such a way that the resonance frequency of the wireless power reception unit 21 almost matches the resonance frequency of the wireless power transmission unit 14. When an amount of deviation between the resonance frequency of the wireless power reception unit 21 and the resonance frequency of the wireless power transmission unit 14 is small, for example, when the resonance frequency of the wireless power reception unit 21 is within a range of □120% of the resonance frequency of the wireless power transmission unit 14, the resonance frequency of the wireless power reception unit 21 and the resonance frequency of the wireless power transmission unit 14 do not necessarily need to match. The cited numerical value is strictly an example, and another numerical value may be employed.

Since magnetic resonant coupling is adopted as an example in the first embodiment, the wireless power reception unit 21 is assumed to include the power-receiving coil 211 and the power-receiving resonant capacitor 212. When wireless power feeding is performed between the terminal support device 1 and the mobile communication terminal 2 by magnetic field coupling, electric field coupling, or electric field resonant coupling, the wireless power reception unit 21 is configured based on each type of coupling.

When the power-receiving coil 211 is positioned at a distance allowing magnetic field resonance with the power-transmitting coil 141, the power-receiving coil 211 receives electric power transmitted from the power-transmitting coil 141. For example, the distance allowing the power-receiving coil 211 to produce magnetic field resonance with the power-transmitting coil 141 is preferably set to a distance longer than the distance between the power-receiving coil 211 and the power-transmitting coil 141 when the mobile communication terminal 2 is attached to the attachment base 11 in the terminal support device 1 by approximately several tens of percents. The cited numerical value is strictly an example, and another numerical value may be employed. When the distance between the power-receiving coil 211 and the power-transmitting coil 141 is longer than the distance allowing the power-receiving coil 211 to produce magnetic field resonance with the power-transmitting coil 141, the power-receiving coil 211 cannot receive electric power transmitted from the power-transmitting coil 141.

Electric power received by the wireless power reception unit 21 is distributed to each unit in the mobile communication terminal 2 including the control unit 22, the battery 23, the touch panel 24, and the wireless communication unit 25.

The battery 23 is a rechargeable secondary battery and is configured with, for example, a lithium-ion battery or a nickel-hydrogen battery. The battery 23 stores driving power required for operation of the mobile communication terminal 2. The battery 23 is charged when electric power received by the wireless power reception unit 21 from the wireless power transmission unit 14 is supplied. When the battery 23 is charged, the state of charge (SOC) of the battery 23 is restored. At least either of electric power received by the wireless power reception unit 21 and electric power stored in the battery 23 is used as driving power for each unit in the mobile communication terminal 2 including the control unit 22, the touch panel 24, and the wireless communication unit 25 depending on the charge status (state of charge) of the battery 23.

The touch panel 24 has functions of both screen display and input operation acceptance. Examples of a method for the input operation acceptance function of the touch panel 24 include a capacitance method, an electromagnetic induction method, a resistive film method, a surface acoustic wave method, and an infrared method.

The wireless communication unit 25 performs wireless communication with an external device. A wireless communication interface (unillustrated) is also provided in the controller 200, and the wireless communication unit 25 can wirelessly communicate with the controller 200. For example, narrow area wireless communication is used as wireless communication between the wireless communication unit 25 and the controller 200. Narrow area wireless communication represents communication with a shorter communication distance compared with wide area wireless communication and specifically represents communication with, for example, a communication distance less than 10 meters. The cited numerical value is strictly an example, and another numerical value may be employed. Various types of short-distance wireless communication with a short communication distance may be used as the narrow area wireless communication, and for example, communication conforming to any communication standard formulated by IEEE, ISO, IEC, or the like [such as Wi-Fi (registered trademark), Bluetooth (registered trademark), or ZigBee (registered trademark)] is used. As an example, a case of performing communication conforming to Wi-Fi (registered trademark) is illustrated in FIG. 1. Examples of a technology used for performing narrow area wireless communication include dedicated short-range communications (DSRC) and radio frequency identification (RFID).

The wireless communication unit 25 may also be connected to an Internet line through a mobile phone communication system (such as LTE, a 3G line, a 4G line, or a 5G line) being wide area wireless communication and perform data communication with an external device on the Internet line.

The control unit 22 performs various types of control of the mobile communication terminal 2. The control unit 22 controls various circuits including the touch panel 24 and the wireless communication unit 25 in the mobile communication terminal 2.

The control unit 22 includes a communication interface 221, a memory 222, and a processor 223. The communication interface 221, the memory 222, and the processor 223 are electrically connected to each other through a bus.

The communication interface 221 includes an interface circuit for electrically connecting the control unit 22 to various types of equipment constituting the mobile communication terminal 2 (such as the touch panel 24 and the wireless communication unit 25). The control unit 22 communicates with another piece of equipment through the communication interface 221.

For example, the memory 222 is configured with an electrically erasable/recordable nonvolatile memory, such as an EEPROM (registered trademark), or a random-access memory capable of high-speed read/write, such as a DRAM or an SRAM. The memory 222 stores an operating program for executing various types of processing in the processor 223, various application software programs, various types of data used when various types of processing are executed by the processor 223, and the like.

Examples of the processor 223 include an IC, an LSI, a CPU, an MPU, and a DSP. The processor 223 may further include an arithmetic circuit such as a logical arithmetic unit or a numerical arithmetic unit. The processor 223 executes various types of processing, based on the program stored in the memory 222.

Since the mobile communication terminal 2 is a general-purpose information communication terminal, various application software programs can be installed in the memory 222. One of the programs is a teaching software program for commanding the controller 200 regarding the motion of the robot 300, based on a teaching operation content on the robot 300. The teaching software program is an application software program for performing registration and editing of an operation program related to the robot 300, condition setting, state display, teaching of the robot 300, a manual operation, and the like.

The control unit 22 executes the teaching software program for controlling the controller 200 in such a way that the robot 300 moves based on an operation content related to a teaching operation on the robot 300. When a worker operates the mobile communication terminal 2 in the teaching operation device 100, the mobile communication terminal 2 commands the controller 200 regarding the motion of the robot 300 through a wireless communication, based on a teaching operation content. The mobile communication terminal 2 provides a wireless teaching operation function of operating (teaching) the robot 300 by execution of arithmetic processing by the processor 223 in accordance with the teaching software program installed in the memory 222 in the control unit 22.

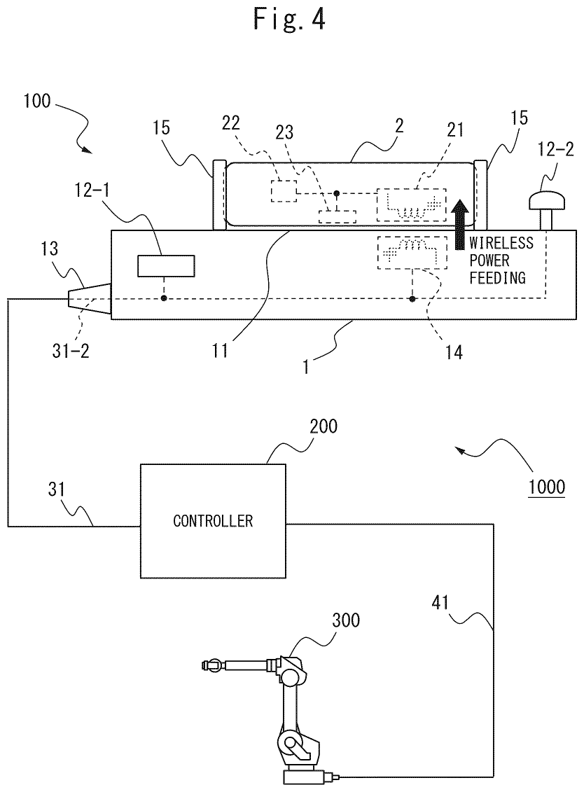

FIG. 4 is a diagram illustrating wireless power feeding and power distribution in the robot control system according to the first embodiment of the present disclosure. In FIG. 4, illustration of the touch panel 24 and the wireless communication unit 25 in the mobile communication terminal 2 is omitted.

The controller 200 supplies part of electric power supplied from the external commercial power source to the terminal support device 1 through the power line 31-2 in the electric cable 31. The terminal support device 1 uses part of the supplied electric power as driving power for each unit in the terminal support device 1 including the enable switch 12-1 and the emergency stop button 12-2. The terminal support device 1 sends part of the remaining supplied electric power to the wireless power transmission unit 14.

By the mobile communication terminal 2 being attached to the attachment base 11 in the terminal support device 1, the state between the wireless power transmission unit 14 in the terminal support device 1 and the wireless power reception unit 21 in the mobile communication terminal 2 enters a wireless-power-feeding-enabled state. For example, when magnetic field resonant coupling is used for wireless power feeding between the terminal support device 1 and the mobile communication terminal 2, the power-receiving coil 211 in the wireless power reception unit 21 is positioned at a distance allowing magnetic field resonance with the power-transmitting coil 141 in the wireless power transmission unit 14 by the mobile communication terminal 2 being attached to the attachment base 11 in the terminal support device 1. The power-transmitting coil 141 in the wireless power transmission unit 14 produces magnetic field resonance with the power-receiving coil 211 in the wireless power reception unit 21 by electric power flowing into the wireless power transmission unit 14 at a predetermined resonance frequency. Consequently, electric power is wirelessly fed from the wireless power transmission unit 14 to the wireless power reception unit 21. In this case, magnetic resonant coupling is adopted as an example. When wireless power feeding is performed between the terminal support device 1 and the mobile communication terminal 2 by magnetic field coupling, electric field coupling, or electric field resonant coupling, wireless power feeding is performed according to an operation principle based on each type of coupling. The battery 23 is charged when electric power received by the wireless power reception unit 21 from the wireless power transmission unit 14 is supplied. At least one or other of the electric power received by the wireless power reception unit 21 and electric power stored in the battery 23 is used as driving power for each unit in the mobile communication terminal 2 including the control unit 22, the touch panel 24, and the wireless communication unit 25 depending on the charge status (state of charge) of the battery 23. An amount of electric power exceeding an amount of driving power for the units in the mobile communication terminal 2 including the control unit 22, the touch panel 24, and the wireless communication unit 25 included in an amount of the electric power received by the wireless power reception unit 21 may be used for charging the battery 23, depending on the charge status (state of charge) of the battery 23.

When the mobile communication terminal 2 is removed from the attachment base 11 in the terminal support device 1, the power-receiving coil 211 in the wireless power reception unit 21 is not positioned at a distance allowing magnetic field resonance with the power-transmitting coil 141 in the wireless power transmission unit 14. Therefore, wireless power feeding is not performed from the wireless power transmission unit 14 to the wireless power reception unit 21. When the mobile communication terminal 2 is removed from the attachment base 11 in the terminal support device 1, electric power stored in the battery 23 is used as driving power for each unit in the mobile communication terminal 2 including the control unit 22, the touch panel 24, and the wireless communication unit 25.

According to the first embodiment of the present disclosure, wireless power feeding is performed from the terminal support device 1 to the mobile communication terminal 2, and therefore, there is no need for the terminal support device 1 to be connected to the mobile communication terminal 2 by a power cable, and driving power for the mobile communication terminal 2 can be easily secured.

According to the first embodiment of the present disclosure, a power cable for supplying power to the mobile communication terminal 2 is not required. Accordingly, the weight of the teaching operation device 100 can be reduced. Further, a power trouble such as unexpected battery exhaustion due to abrupt disconnection of a power cable or a break of a power cable can be avoided.

According to the first embodiment of the present disclosure, a power cable is not required, and therefore, there is no need to provide a connector for connecting a power cable in both the terminal support device 1 and the mobile communication terminal 2. Accordingly, there is no need for each of the terminal support device 1 and the mobile communication terminal 2 to be provided with a dustproof structure and a waterproof structure for the connector. Therefore, reduction in manufacture costs, improvement in convenience during use, and expansion of a usable environment can be achieved.

For example, an industrial robot may be installed in an explosionproof space depending on the usage purpose. In general, when an energizable cable without being limited to a power cable is inserted to or extracted from a connector, a micro electric spark may occur in a terminal part of the connector. There is a risk of an explosion caused by occurrence of an electric spark in an explosionproof space. Therefore, insertion and extraction of a cable to and from a connector is prohibited in an explosionproof space for safety reasons. Therefore, when a mobile communication terminal is charged by using a power cable, the mobile communication terminal needs to be temporarily brought out of the explosionproof space, and the mobile communication terminal cannot be used during that time. On the other hand, according to the first embodiment of the present disclosure, insertion and extraction of a power cable to and from a connector is not performed, and therefore, the mobile communication terminal 2 can be charged in an explosionproof space where an industrial robot is installed, Further, use of the mobile communication terminal 2 can be continued.

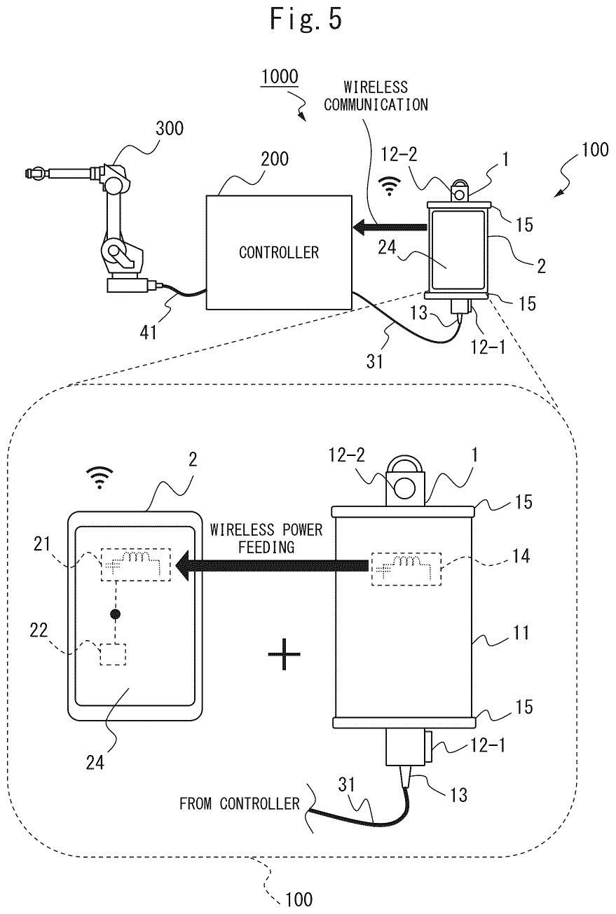

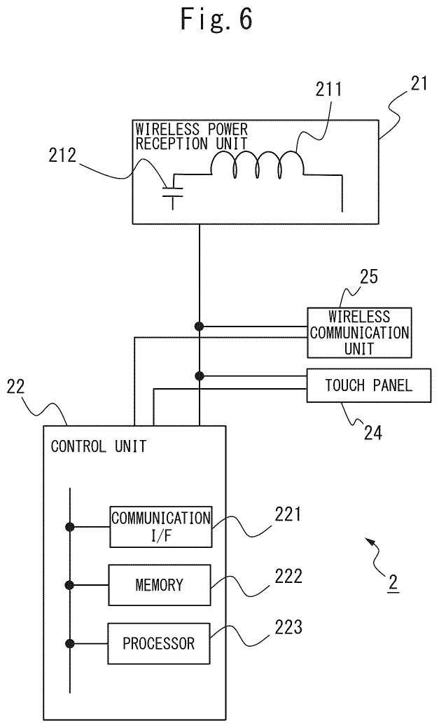

FIG. 5 is a diagram illustrating a robot control system according to the second embodiment of the present disclosure. FIG. 6 is a block diagram illustrating a mobile communication terminal in the robot control system according to the second embodiment of the present disclosure. FIG. 2 is applied as a block diagram of a terminal support device 1 in the robot control system according to the second embodiment of the present disclosure.

The second embodiment of the present disclosure differs from the first embodiment in that a mobile communication terminal 2 does not include a battery.

The robot control system 1000 according to the second embodiment of the present disclosure includes a teaching operation device 100 and a controller 200.

The controller 200 connected to a robot 300 through a robot cable 41 is as described in the first embodiment with reference to FIG. 1 and FIG. 4. The controller 200 is connected to an external commercial power source (unillustrated). The controller 200 distributes electric power supplied from the commercial power source into driving power for the controller 200 itself and electric power supplied to the terminal support device 1. Part of the electric power supplied from the commercial power source to the controller 200 is supplied to the terminal support device 1 through a power line 31-2 in an electric cable 31. The controller 200 may supply part of the electric power supplied from the commercial power source to the robot 300 as driving power.

The teaching operation device 100 is configured with the mobile communication terminal 2 and the terminal support device 1.

The terminal support device 1 is as described in the first embodiment with reference to FIG. 1, FIG. 2, and FIG. 4. The terminal support device 1 uses part of supplied electric power as driving power for each unit in the terminal support device 1 including an enable switch 12-1 and an emergency stop button 12-2. The terminal support device 1 wirelessly feeds part of the remaining supplied electric power to the mobile communication terminal 2 through the wireless power transmission unit 14. As an example, magnetic field resonant coupling is used for wireless power feeding between the terminal support device 1 and the mobile communication terminal 2 also in the second embodiment.

The mobile communication terminal 2 is attachably and detachably attached to the attachment base 11 in the terminal support device 1. The mobile communication terminal 2 is a general-purpose portable information communication terminal that can wirelessly communicate with an external device. Examples of the mobile communication terminal 2 include a tablet terminal (tablet PC) and a smartphone.

The mobile communication terminal 2 includes a wireless power reception unit 21, a control unit 22, a touch panel 24, and a wireless communication unit 25. The wireless power reception unit 21, the control unit 22, the touch panel 24, and the wireless communication unit 25 are as described in the first embodiment with reference to FIG. 1, FIG. 3, and FIG. 4. As an example, magnetic field resonant coupling is used for wireless power feeding between the terminal support device 1 and the mobile communication terminal 2 also in the second embodiment, and therefore, the wireless power reception unit 21 is configured with a resonance circuit including a power-receiving coil 211 and a power-receiving resonant capacitor 212. The relation between the resonance frequency of the wireless power reception unit 21 and the resonance frequency of the wireless power transmission unit 14, and the position relation between the power-receiving coil 211 and the power-transmitting coil 141 are as described in the first embodiment. Since magnetic resonant coupling is adopted as an example also in the second embodiment, the wireless power reception unit 21 is assumed to include the power-receiving coil 211 and the power-receiving resonant capacitor 212. When wireless power feeding is performed between the terminal support device 1 and the mobile communication terminal 2 by magnetic field coupling, electric field coupling, or electric field resonant coupling, the wireless power reception unit 21 is configured based on each type of coupling.

According to the second embodiment, electric power received by the wireless power reception unit 21 is distributed to each unit in the mobile communication terminal 2 including the control unit 22, the touch panel 24, and the wireless communication unit 25.

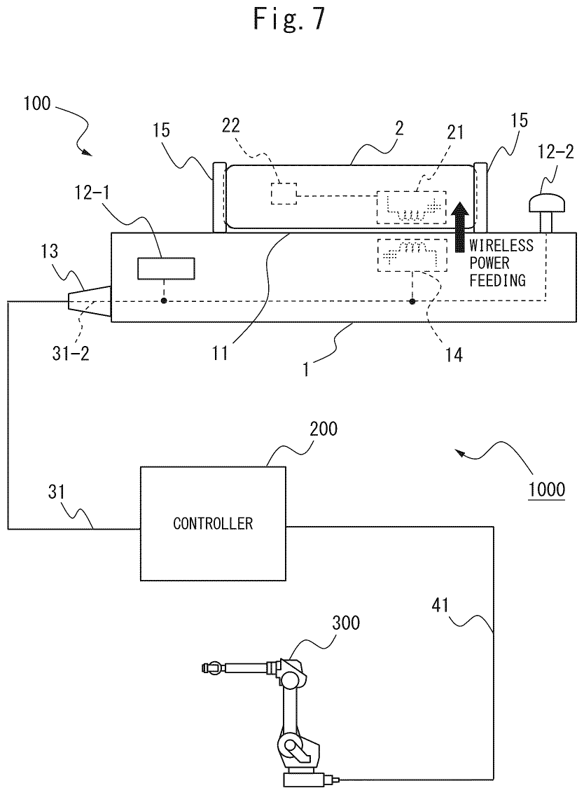

FIG. 7 is a diagram illustrating wireless power feeding and power distribution in the robot control system according to the second embodiment of the present disclosure. Illustration of the touch panel 24 and wireless communication unit 25 in the mobile communication terminal 2 is omitted in FIG. 7.

The controller 200 supplies part of electric power supplied from the external commercial power source to the terminal support device 1 through the power line 31-2 in the electric cable 31. The terminal support device 1 uses part of the supplied electric power as driving power for each unit in the terminal support device 1 including the enable switch 12-1 and the emergency stop button 12-2. The terminal support device 1 sends part of the remaining supplied electric power to the wireless power transmission unit 14.

When the mobile communication terminal 2 is attached to the attachment base 11 in the terminal support device 1, wireless power feeding is performed between the wireless power transmission unit 14 in the terminal support device 1 and the wireless power reception unit 21 in the mobile communication terminal 2. For example, when magnetic field resonant coupling is used for wireless power feeding between the terminal support device 1 and the mobile communication terminal 2, the power-receiving coil 211 in the wireless power reception unit 21 is positioned at a distance allowing magnetic field resonance with the power-transmitting coil 141 in the wireless power transmission unit 14 by the mobile communication terminal 2 being attached to the attachment base 11 in the terminal support device 1. The power-transmitting coil 141 in the wireless power transmission unit 14 produces magnetic field resonance with the power-receiving coil 211 in the wireless power reception unit 21 by electric power flowing into the wireless power transmission unit 14 at a predetermined resonance frequency. Consequently, electric power is wirelessly fed from the wireless power transmission unit 14 to the wireless power reception unit 21. The electric power received by the wireless power reception unit 21 from the wireless power transmission unit 14 is used as driving power for each unit in the mobile communication terminal 2 including the control unit 22, the touch panel 24, and the wireless communication unit 25.

When the mobile communication terminal 2 is removed from the attachment base 11 in the terminal support device 1, the power-receiving coil 211 in the wireless power reception unit 21 is not positioned at a distance allowing magnetic field resonance with the power-transmitting coil 141 in the wireless power transmission unit 14. Therefore, wireless power feeding is not performed from the wireless power transmission unit 14 to the wireless power reception unit 21. Therefore, driving power is not supplied to each unit in the mobile communication terminal 2 including the control unit 22, the touch panel 24, and the wireless communication unit 25, and therefore, the mobile communication terminal 2 does not operate. In other words, the control unit 22 does not execute a teaching software program. The wireless communication unit 25 does not wirelessly communicate with an external device and naturally does not wirelessly communicate with the controller 200.

Thus, in a state of the mobile communication terminal 2 being attached to the attachment base 11 in the terminal support device 1, wireless power feeding is performed from the terminal support device 1 to the mobile communication terminal 2, and therefore, the mobile communication terminal 2 operates. Accordingly, a worker can perform a teaching operation on the robot 300 by using the mobile communication terminal 2. When the worker removes the mobile communication terminal 2 from the attachment base 11 in the terminal support device 1, wireless power feeding is not performed from the terminal support device 1 to the mobile communication terminal 2, and therefore, the mobile communication terminal 2 does not operate, and the wireless communication between the wireless communication unit 25 and the controller 200 is forcibly interrupted. Consequently, the worker cannot perform a teaching operation on the robot 300 by using the mobile communication terminal 2. When the mobile communication terminal 2 is subsequently attached to the terminal support device 1 again, wireless power feeding is performed from the terminal support device 1 to the mobile communication terminal 2, and therefore, the mobile communication terminal 2 operates; and therefore, the worker can perform a teaching operation on the robot 300 by using the mobile communication terminal 2.

According to the second embodiment of the present disclosure, wireless power feeding is performed from the terminal support device 1 to the mobile communication terminal 2, similarly to the first embodiment, and therefore, there is no need to connect the terminal support device 1 to the mobile communication terminal 2 by a power cable, and driving power for the mobile communication terminal 2 can be easily secured.

According to the second embodiment of the present disclosure, a battery is not provided in the mobile communication terminal 2, and therefore, weight reduction and cost reduction of the mobile communication terminal 2 can be achieved. Further, a power cable for supplying power to the mobile communication terminal 2 is not required. Accordingly, the weight of the teaching operation device 100 can be reduced.

According to the second embodiment of the present disclosure, a battery is not provided in the mobile communication terminal 2, and therefore, there is no concern as regards unexpected battery exhaustion, and there is no need for battery replacement work due to battery degradation.

According to the second embodiment of the present disclosure, a power cable is not required, similarly to the first embodiment, and therefore, there is no need to provide a connector for connecting a power cable in both the terminal support device 1 and the mobile communication terminal 2. Accordingly, there is no need for each of the terminal support device 1 and the mobile communication terminal 2 to be provided with a dustproof structure and a waterproof structure for the connector. Therefore, reduction in manufacture costs, improvement in convenience during use, and expansion of a usable environment can be achieved. Since insertion and extraction of a power cable to and from a connector is not performed, the mobile communication terminal 2 can be charged in an explosionproof space where an industrial robot is installed, and use of the mobile communication terminal 2 can be continued.

According to the second embodiment of the present disclosure, by a worker merely performing an operation of removing the mobile communication terminal 2 from the attachment base 11 in the terminal support device 1, the wireless communication between the wireless communication unit 25 and the controller 200 is forcibly interrupted, and a teaching operation on the robot 300 using the mobile communication terminal 2 by the worker is prohibited. Therefore, for example, when a dangerous situation in which a teaching operation on the robot 300 using the mobile communication terminal 2 needs to be immediately stopped occurs, safety can be easily secured by the worker merely performing the operation of removing the mobile communication terminal 2 from the attachment base 11 in the terminal support device 1. For example, the teaching operation device 100 including the terminal support device 1 and the mobile communication terminal 2 according to the second embodiment of the present disclosure conforms to the safety standard related to cableless control of machinery EN62745 (IEC62745).

As described above, a battery is not provided in the mobile communication terminal 2 according to the second embodiment of the present disclosure. As a modified example of the second embodiment, a capacitor temporarily holding electric power received by the wireless power reception unit may be provided for the purpose of stabilization of operation of the mobile communication terminal 2.

According to at least one embodiment described above, driving power for the mobile communication terminal 2 can be easily secured in the teaching operation device 100 configured with the mobile communication terminal 2 and the terminal support device 1, and the robot control system 1000 including the teaching operation device 100. In other words, various difficulties in securing of power related to the mobile communication terminal 2, such as unexpected battery exhaustion and use in an environment in which securing of driving power is not easy, can be eliminated.

While the present disclosure has been described in detail above, the present disclosure is not limited to each embodiment described above. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto. Further, the above holds when a numerical value or a mathematical expression is used in the description of the aforementioned embodiments.

The following Supplementary Notes are further disclosed with regard to the aforementioned embodiments and the modified examples thereof.

### (Supplementary Note 1)

A terminal support device 1 including:
an attachment base 11 attachably and detachably attaching a mobile communication terminal 2 configured to command a controller 200 of a robot 300 regarding a motion of the robot 300 through a wireless communication, based on a teaching operation content;
a safety switch 12 outputting a safety signal to the controller 200;
an interface unit 13 configured to be connected to an electric cable 31 including a signal line 31-1 transmitting the safety signal to the controller 200 and a power line 31-2 transmitting electric power supplied from the controller 200; and a wireless power transmission unit 14 configured to wirelessly feed part of electric power received from the controller 200 through the power line 31-2 in the electric cable 31 and the interface unit 13 to the mobile communication terminal 2.

### (Supplementary Note 2)

The terminal support device 1 according to Supplementary Note 1, wherein
the safety switch 12 includes:
an enable switch outputting, as the safety signal, an enable signal permitting control of a motion of the robot 300 by the controller 200 when being depressed and prohibiting control of a motion of the robot 300 by the controller 200 when depression is released; and
an emergency stop button outputting, as the safety signal, an emergency stop signal commanding the controller 200 to cause the robot 300 to make an emergency stop when being operated.

### (Supplementary Note 3)

A teaching operation device 100 including:
a mobile communication terminal 2 configured to command a controller 200 of a robot 300 regarding a motion of the robot 300 through a wireless communication, based on a teaching operation content; and
the terminal support device 1 according to Supplementary Note 2, wherein
the mobile communication terminal 2 includes a wireless power reception unit 21 configured to receive electric power wirelessly fed from the wireless power transmission unit 14 in the terminal support device 1.

### (Supplementary Note 4)

The teaching operation device 100 according to Supplementary Note 3, wherein
the mobile communication terminal 2 includes a battery 23 storing electric power received by the wireless power reception unit 21, and
at least either of electric power received by the wireless power reception unit 21 and electric power stored in the battery 23 is used as driving power for the mobile communication terminal 2 depending on charge status of the battery 23.

### (Supplementary Note 5)

The teaching operation device 100 according to Supplementary Note 3, wherein
electric power received by the wireless power reception unit 21 is used as driving power for the mobile communication terminal 2.

### (Supplementary Note 6)

The teaching operation device 100 according to any one of Supplementary Notes 3 to 5, wherein
the mobile communication terminal 2 includes a control unit 22 configured to execute a teaching software program for controlling the controller 200 in such a way that the robot 300 moves based on a teaching operation content on the robot 300.

### (Supplementary Note 7)

The teaching operation device 100 according to any one of Supplementary Notes 3 to 6, wherein
the mobile communication terminal 2 is either one of a tablet terminal and a smartphone.
   (Supplementary Note 8) A robot control system 1000 including:
a controller 200 of a robot 300; and
the teaching operation device 100 according to any one of Supplementary Notes 3 to 7.

### REFERENCE SIGNS LIST

1 Terminal support device
2 Mobile communication terminal
11 Attachment base
12 Safety switch
12-1 Enable switch
12-2 Emergency stop button
13 Interface unit
14 Wireless power transmission unit
15 Holding mechanism
21 Wireless power reception unit
22 Control unit
23 Battery
24 Touch panel
25 Wireless communication unit
31 Electric cable
31-1 Signal line
31-2 Power line
41 Robot cable 41
100 Teaching operation device
141 Power-transmitting coil
142 Power-transmitting resonant capacitor
200 Controller
211 Power-receiving coil
212 Power-receiving resonant capacitor
300 Robot
1000 Robot control system

1. A terminal support device comprising:
an attachment base attachably and detachably attaching a mobile communication terminal configured to command a controller of a robot regarding a motion of the robot through a wireless communication, based on a teaching operation content;
a safety switch configured to output a safety signal to the controller;
an interface unit configured to be connected to an electric cable including a signal line configured to transmit the safety signal to the controller and a power line configured to transmit electric power supplied from the controller; and
a wireless power transmission unit configured to wirelessly feed part of electric power received from the controller through the power line in the electric cable and the interface unit to the mobile communication terminal.

2. The terminal support device according to claim 1, wherein the safety switch includes:
an enable switch configured to output, as the safety signal, an enable signal permitting control of a motion of the robot by the controller when being depressed and prohibiting control of a motion of the robot by the controller when depression is released; and
an emergency stop button configured to output, as the safety signal, an emergency stop signal commanding the controller to cause the robot to make an emergency stop when being operated.

3. A teaching operation device comprising:
a mobile communication terminal configured to command a controller of a robot regarding a motion of the robot through a wireless communication, based on a teaching operation content; and
the terminal support device according to claim 2, wherein
the mobile communication terminal includes a wireless power reception unit configured to receive electric power wirelessly fed from the wireless power transmission unit in the terminal support device.

4. The teaching operation device according to claim 3, wherein
the mobile communication terminal includes a battery configured to store electric power received by the wireless power reception unit, and
at least either of electric power received by the wireless power reception unit and electric power stored in the battery is used as driving power for the mobile communication terminal depending on charge status of the battery.

5. The teaching operation device according to claim 3, wherein electric power received by the wireless power reception unit is used as driving power for the mobile communication terminal.

6. The teaching operation device according to claim 3, wherein the mobile communication terminal includes a control unit configured to execute a teaching software program for controlling the controller in such a way that the robot moves based on a teaching operation content on the robot.

7. The teaching operation device according to claim 3, wherein the mobile communication terminal is either one of a tablet terminal and a smartphone.

8. A robot control system comprising:
a controller of a robot; and
the teaching operation device according to claim 3.
